(19) United States
(12) Patent Application Publication
(10) Pub. No.: US 2010/0142353 A1
(43) Pub. Date: Jun. 10, 2010

(54) Record Medium, Optical Disk Unit Using It, and Recording Method

(75) Inventors: Shohei Inoue, Fukuoka (JP); Hideaki Horio, Fukuoka (JP); Taiichi Mori, Fukuoka (JP); Tetsuya Araki, Fukuoka (JP); Kouichi Bairin, Saga (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/631,630

(22) Filed: Dec. 4, 2009

(30) Foreign Application Priority Data
Dec. 4, 2008 (JP) 2008-309401

(51) Int. Cl. G11B 7/00; G11B 7/26

(52) U.S. Cl. 369/103; 369/283; G9B/7; G9B/7.194

(57) ABSTRACT

To accomplish the object, the invention provides a record medium including a plate body 2; multiple hologram layers 3 formed in the thickness direction of the plate body 2; and hologram bands 4 formed in at least one of the multiple hologram layers 3. The hologram band 4 is formed with erasure areas 4A and 4B of the hologram band 4 with no hologram band 4 in the direction orthogonal to the length direction of the hologram band 4.

### BACKGROUND

1. Field of the Invention

This invention relates to a record medium, an optical disk unit using the record medium, and a recording method.

2. Description of the Related Art

In recent years, various methods of performing multilayer recording on a record medium have been proposed to increase the record capacity.

That is, multiple micro-hologram layers are provided in a plate body in the thickness direction of the plate body; since multiple micro-hologram layers are provided, the record capacity becomes extremely large. (Refer to Patent Document 1.)

The feature of the conventional example shown in Patent Document 1 is as follows: Since the record medium is provided with multiple micro-hologram layers, an optical disk unit using the record medium for recording and playing back can perform digital recording by applying light to a micro-hologram of a record portion of the micro-hologram layer from one side of the record medium and causing optical alteration to form a portion where the micro-hologram is erased and applying no light to form a portion where the micro-hologram is left.

At the playback time, light can be applied from one side of the record medium to the portion of the micro-hologram layer where the micro-hologram is erased and the portion where the micro-hologram is left and reflected light therefrom can be read for performing digital playback.

In contrast, in examples preceding the conventional example, to form a micro-hologram on a record medium, light must be applied from both sides of the record medium for causing optical interference to occur to form a micro-hologram. At the playback time, in the examples preceding the conventional example, light can be applied from one side of the record medium to the micro-hologram of the micro-hologram layer and reflected light therefrom can be read for performing digital playback.

That is, according to the conventional example shown in Patent Document 1, the optical disk unit for recording and playing back has the feature of a simplified structure because a light supply path needs only to be provided on one side of the record medium.

Patent Document 1: U.S. Pat. No. 7,388,695

As described above, according to the conventional example shown in Patent Document 1, a light supply path needs only to be provided on one side of the record medium for the optical disk unit for recording and playing back the record medium, so that the structure is simplified.

However, in the conventional example, for the previously formed micro-hologram, the micro-hologram is erased using light of the same width as the width of the micro-hologram (the direction orthogonal to the rotation direction) at the recording time and thus noise occurrence at the playback time becomes a problem (which will be discussed in detail while comparing in the description of one embodiment of the invention).

### SUMMARY

It is therefore an object of the invention to suppress occurrence of noise at the playback time.

To accomplish the object, the invention provides a record medium including a plate body; multiple hologram layers formed in the thickness direction of the plate body; and hologram bands formed in at least one of the multiple hologram layers, wherein the hologram band is formed with a hologram band erasure area with no hologram band in the direction orthogonal to the length direction of the hologram band.

As described above, the invention provides the record medium including the plate body; the multiple hologram layers formed in the thickness direction of the plate body; and the hologram bands formed in at least one of the multiple hologram layers, wherein the hologram band is formed with a hologram band erasure area with no hologram band in the direction orthogonal to the length direction of the hologram band, so that occurrence of noise at the playback time can be suppressed.

That is, each hologram band erasure area with no hologram band is formed in the direction orthogonal to the length direction of the hologram band. Thus, in the erasure area, non-erasure hologram remaining in the width direction is small and consequently occurrence of noise at the playback time can be suppressed.

### BRIEF DESCRIPTION OF THE DRAWINGS

In the accompanying drawings:

FIG. 1 is a block diagram to show an embodiment of the invention;

FIG. 2 is a perspective view to show a hologram disk (record medium) of the embodiment of the invention;

FIG. 3 is a fragmentary enlarged perspective view of FIG. 2;

FIG. 4 is a fragmentary enlarged plan view to show the hologram disk (record medium) of the embodiment of the invention;

FIG. 5 is a fragmentary enlarged plan view of FIG. 4;

FIG. 6 is a fragmentary enlarged plan view to show the playback time in FIG. 4;

FIG. 7 is a characteristic drawing to show the playback time in FIG. 4;

FIG. 8 is a plan view to show a hologram disk (record medium) of a comparison example of the invention;

FIG. 9 is a fragmentary enlarged plan view of FIG. 8;

FIG. 10 is a fragmentary enlarged plan view to show the playback time in FIG. 8;

FIG. 11 is a characteristic drawing to show the playback time in FIG. 8;

FIG. 12 is a block diagram at the recording time and the playback time of a CD in the embodiment of the invention;

FIG. 13 is a block diagram to show the recording time and the playback time of a DVD in the embodiment of the invention; and

FIG. 14 is a block diagram to show the recording time and the playback time of a BD in the embodiment of the invention.

### DETAILED DESCRIPTION

An embodiment of the invention will be discussed below with the accompanying drawings:

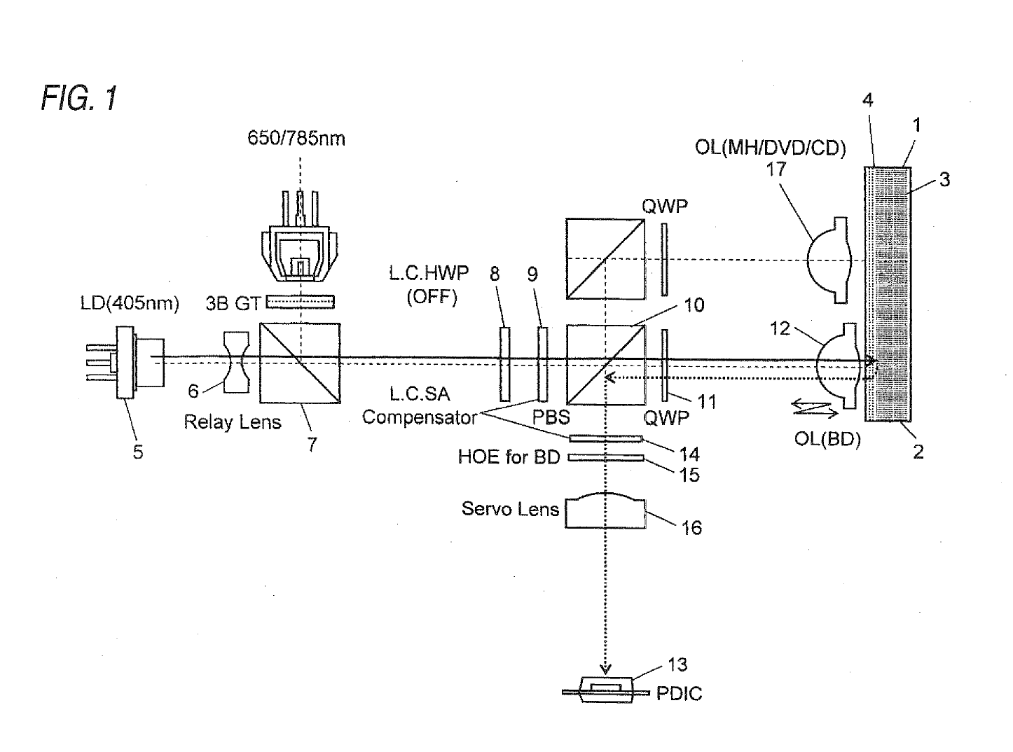

FIG. 1 shows an optical disk unit capable of recording and playing back a hologram disk (MH), a CD, a DVD, and a BD as a record medium.

To begin with, recording and playing back when a hologram disk (MH) is used as a record medium will be discussed.

A hologram disk (MH) 1 shown in FIG. 1 is formed of a plate body 2 shaped like a disk and although not shown in FIG. 1, a drive shaft is inserted into a through hole made in the center portion for rotating the disk.

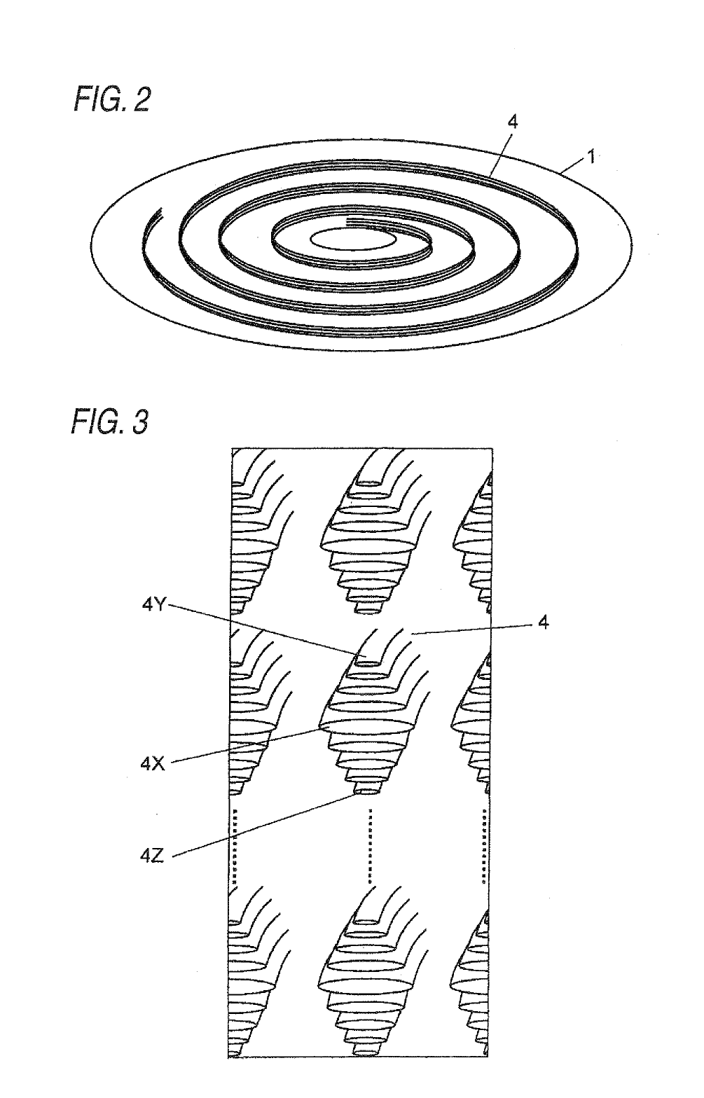

As shown in FIG. 1, the hologram disk (MH) 1 used in the embodiment is previously formed with a plurality of hologram layers 3 in the plate body 2 and the plurality of hologram layers 3 are formed of continuous spiral hologram bands 4 as shown in FIGS. 2 and 3 (the continuous spiral hologram bands 4 of the embodiment are concentrically spiral as seen in FIG. 2).

Although the bands are spiral in the embodiment, a plurality of concentric hologram bands different in diameter may be placed as one layer and a plurality of layers may be stacked.

That is, using the art described above in Patent Document 1, each hologram layer 3 made up of a plurality of hologram bands placed up and down is formed; at the recording time, light is applied to the micro-hologram band 4 and optical alteration is caused to erase the micro-hologram band 4 of the portion and the micro-hologram band 4 of a portion where no light is applied is held as the original state, namely, a non-erasure state, so that digital recording of “1” “0” can be accomplished.

At the playback time, a digital signal of “1” “0” is read and is played back.

One of the features in the embodiment is that each of the hologram layers 3 is made up of continuous spiral hologram bands 4, as shown in FIGS. 2 and 3.

Each hologram band 4 has a plurality of interference fringes in the up and down direction as shown in FIG. 3. Of interference fringes in the up and down direction, an intermediate layer portion in the up and down direction (for example, 4X) has a wide width (a direction orthogonal to the length direction of the hologram band 4); a higher layer (for example, 4Y) above the intermediate layer portion (for example, 4X) has a narrower width and a lower layer (for example, 4Z) below the intermediate layer portion (for example, 4X) has a narrower width.

Recording and playing back the hologram band 4 formed on the hologram disk (MH) 1 will be discussed below with FIGS. 1 to 3:

Blue laser light (405 nm) emitted from a laser diode 5 in FIG. 1 passes through a relay lens 6, a beam splitter 7, a liquid crystal half wave plate 8, a spherical aberration correction element 9, a beam splitter 10, and a quarter wave plate 11, and is applied to the hologram band 4 of the target layer (the target layer in the depth direction) of the hologram layers 3 through a lens 12 (to focus on the target layer (the layer in the depth direction), the distance between the lens 12 and the hologram disk (MH) 1 is made variable).

Since the time is the recording time, the laser light applied to the hologram band 4 is strengthened (about 10 times that at the reading time); accordingly, optical alteration is caused to occur in the hologram band 4 of the portion where the laser light is applied and the hologram of the portion is erased and optical alteration is not caused to occur in the hologram band 4 of the portion where the laser light is not applied and the hologram of the portion is not erased. This means that digital recording of a digital signal “1” “0” is performed.

The beam splitter 7 allows the blue laser light to pass through, but reflects red laser light and infrared laser light.

The liquid crystal half wave plate 8 changes the polarization direction by applying a voltage; it is OFF in FIG. 1.

Further, the beam splitter 10 allows P polarization to pass through and reflects S polarization.

Next, playing back will be discussed.

The dashed line in FIG. 1 indicates the signal playing back time; at this time, the laser light applied to the hologram band 4 is weakened (about one-tenth that at the writing time) and thus optical alteration does not occur in the hologram band 4 of the hologram layer 3 and devotedly a reflected wave from the hologram band 4 is received at a light reception element 13 to obtain a playback signal.

The reflected wave from the hologram band 4 once passes through the quarter wave plate 11 before arriving at the lens 12 and thus again passes through as the reflected wave and becomes from P polarization to S polarization and therefore is reflected on the beam splitter 10 and next arrives at the light reception element 13 as described above through a spherical aberration correction element 14, a BD tracking element 15, and a focus adjustment lens 16, and reading is performed.

The basic configuration and operation are seen from the description give above. Then, the largest feature in the embodiment will be discussed below:

In the embodiment, at the recording time, the blue laser light emitted from the laser diode 5 is applied to the hologram band 4 of the target layer 3 for erasing the hologram band 4 of the light-applied portion.

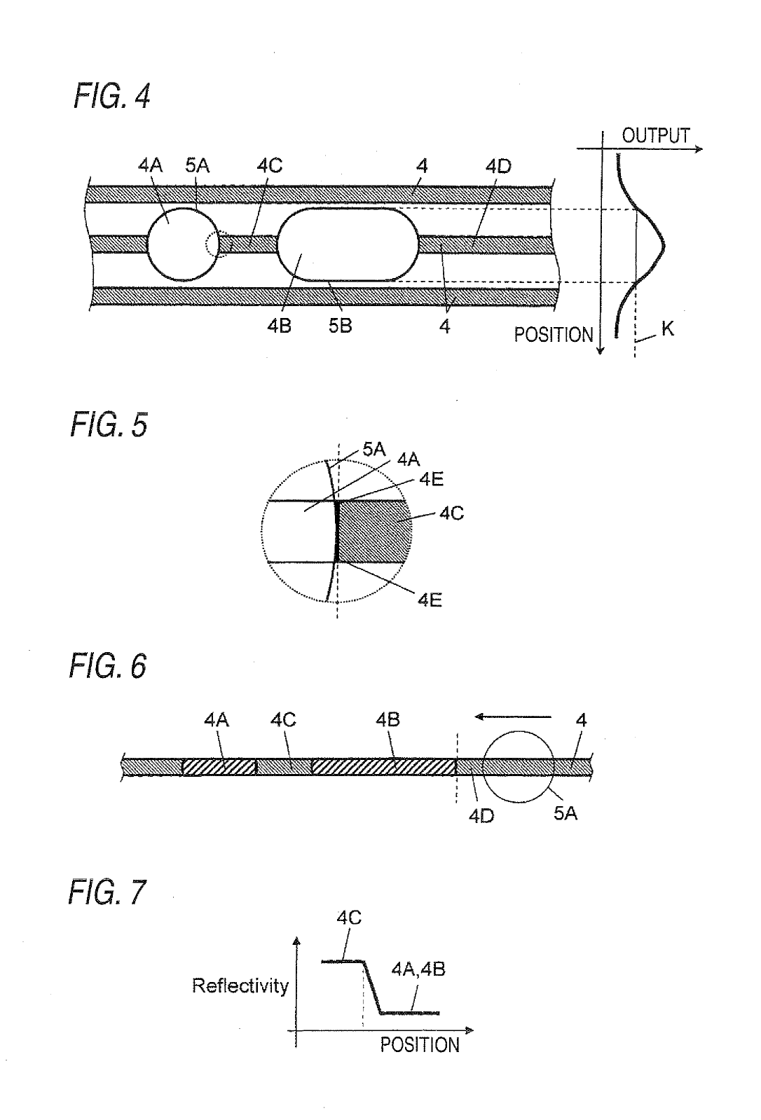

4A and 4B portions in FIGS. 4 and 6 are erasure areas of the hologram band 4 (digital signal, for example, “0”); the erasure area 4A is a single erasure area and the erasure area 4B indicates a state in which the erasure area 4A of the hologram band 4 is formed continuously in the length direction of the hologram band 4.

In the hologram band 4 except the erasure area 4A or 4B, for example, non-erasure areas (digital signal, for example, “1”) 4C and 4D are provided. The non-erasure area 4C is a single non-erasure area and the non-erasure area 4D indicates a state in which the non-erasure area 4C is formed continuously.

In the embodiment, 5A shown in the erasure area 4A in FIG. 4 denotes the blue laser light (circular light) emitted from the laser diode 5 and applied to the hologram band 4. The magnitude of the laser light (circular light) 5A is an energy level exceeding a dashed line K at the right end of FIG. 4. That is, the hologram band 4 of the portion to which the laser light (circular light) 5A at the energy level exceeding the dashed line K is applied is altered and is erased. In the embodiment, the magnitude portion of the energy level exceeding the dashed line K is represented as the laser light (circular light) 5A.

Likewise, an ellipse 5B shown in the erasure area 4B in FIG. 4 indicates a state in which the blue laser light (circular light) 5A emitted from the laser diode 5 is continuously applied to the hologram band 4; the hologram band 4 in the range of the ellipse 5B is also altered and is erased.

It is important that in the embodiment, as shown in FIG. 4, the blue laser light (circular light) 5A applied to the hologram band 4 has a larger diameter than the width in the direction orthogonal to the length direction of the hologram band 4.

That is, in so doing, as shown in FIG. 5, if the blue laser light (circular light) 5A emitted from the laser diode 5 is circular light, a remaining area 4E of the hologram remaining on the non-erasure area 4C side of the erasure area 4A lessens.

That is, the fact that the remaining area 4E of the hologram formed adjacent to the erasure area 4A lessens is the largest feature of the embodiment and accordingly, noise occurrence at the playback time can be suppressed.

Further, the blue laser light 5A applied to the hologram band 4 is set to a diameter smaller than the width from the boundary on the hologram band 4 side to which the blue laser light 5A is applied in one hologram band 4 adjacent to the hologram band 4 to which the blue laser light 5A is applied to the boundary on the hologram band 4 side to which the blue laser light 5A is applied in an opposite hologram band 4 adjacent to the hologram band 4 to which the blue laser light 5A is applied, so that the effect on the adjacent hologram band 4 does not occur.

In the embodiment, the remaining area 4E of the hologram is very small and thus the boundary between the erasure area 4A and the non-erasure area 4C is shaped almost like a straight line.

Next, this point will be discussed with FIGS. 6 and 7.

FIG. 6 shows a state in which the blue laser light (circular light) 5A emitted from the laser diode 5 is continuously applied to the hologram band 4 at the playback time.

Since the lens 12 is also used at the playback time, the laser light (circular light) 5A is continuously applied from the laser diode 5.

The laser light (circular light) 5A is continuously applied, so that reflected light occurs from the hologram band 4. At the time, hologram exists in the non-erasure area 4C as seen in FIG. 3 and thus reflected light is much and the state becomes the state on the left of FIG. 7.

In contrast, the hologram in FIG. 3 is erased in the erasure area 4A, 4B in FIG. 6 and thus reflected light is small and the state becomes the state on the right of FIG. 7.

Here, the fact that the remaining area 4E of the hologram remaining on the non-erasure area 4C side of the erasure area 4A previously described with reference to FIG. 5 lessens means that the light amount difference between the non-erasure area 4C and the erasure area 4A, 4B is large and moreover the slope becomes steep in FIG. 7. The fact that the light amount difference is large and moreover the slope becomes steep means that the criterion for determining a digital signal “1” “0” from the light reception amount at the light reception element 13 is easy to set and a determination is also easy to make. Consequently, occurrence of noise at the playback time can be suppressed.

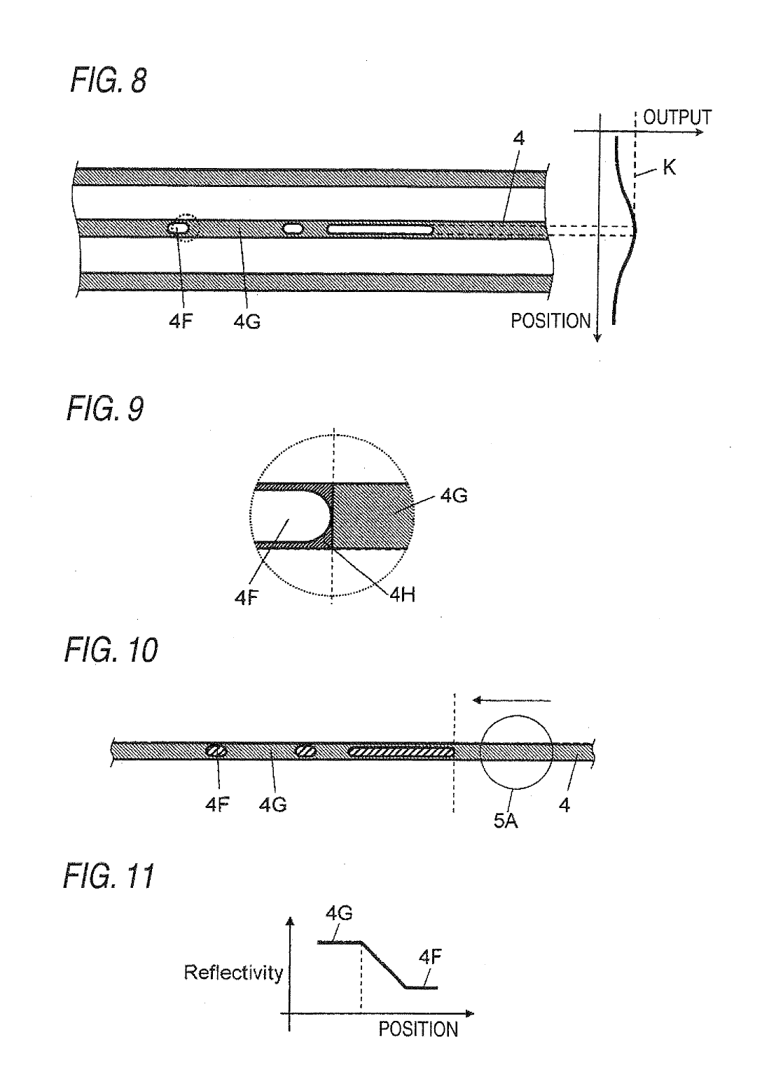

In contrast, FIG. 8 shows the case where blue laser light applied to the hologram band 4 is set to a diameter which is the same as or smaller than the width in the direction orthogonal to the length direction of the hologram band 4.

At this time, as shown in FIGS. 9 and 10, if blue laser light emitted from the laser diode 5 is circular light, a remaining area 4H of the hologram remaining on the non-erasure area 4G side of an erasure area 4F in FIG. 8 becomes large and consequently occurrence of noise at the playback time becomes a problem.

Here, the fact that the remaining area 4H of the hologram remaining on the non-erasure area 4G side of the erasure area 4F previously described with reference to FIG. 9 becomes large means that the light amount difference between the non-erasure area 4G and the erasure area 4F is small and moreover the slope becomes mild in FIG. 11. In such a state, the criterion for determining a digital signal “1” “0” from the light reception amount at the light reception element 13 is hard to set and a determination is also hard to make. Consequently, occurrence of noise at the playback time becomes a problem.

As described above, according to the embodiment, the criterion for determining a digital signal “1” “0” from the light reception amount at the light reception element 13 is easy to set and a determination is also easy to make. Consequently, occurrence of noise at the playback time can be suppressed; this is a large feature of the embodiment of the invention.

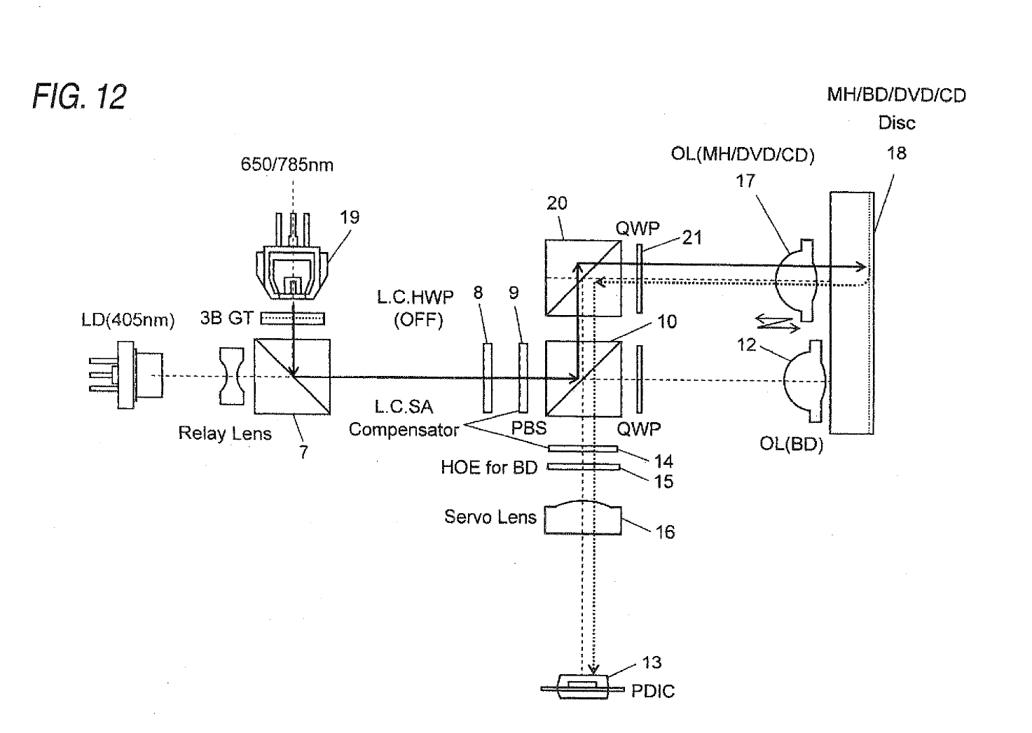

FIG. 12 shows a state in which the lens 17 is utilized for recording and playing back of a CD 18.

That is, the CD 18 records a signal on a side at a distance from the lens 17 or reads a signal therefrom and thus a lens 17 having smaller NA than the lens 12 is utilized.

In this case, infrared laser light (785 nm) is emitted from a laser diode 19 and is reflected on the beam splitter 7 and a voltage is applied to the liquid crystal half wave plate 8 and thus the laser light is deflected as S polarization and is reflected on the beam splitter 10.

The infrared laser light reflected on the beam splitter 10 is reflected on a reflector 20 and passes through a quarter wave plate 21 and then is applied to the target portion of the CD 18 through the lens 17.

Since this time is the recording time, the laser light applied to the CD 18 is made stronger than that at the reading time and accordingly data is recorded on the CD 18 to which the laser light has been applied.

Next, playback of the CD 18 will be discussed.

The dashed line in FIG. 12 indicates the signal playback time; at this time, the laser light applied to the CD 18 is made weaker than that at the recording time and thus devotedly the reflected wave from the CD 18 is received at the light reception element 13 to provide a playback signal.

The reflected wave from the CD 18 once passes through the quarter wave plate 21 before arriving at the lens 17 and thus again passes through as the reflected wave and becomes from S polarization to P polarization and therefore is reflected on the reflector 20 and passes through the beam splitter 10 and next arrives at the light reception element 13 as described above through the spherical aberration correction element 14, the BD tracking element 15, and the focus adjustment lens 16.

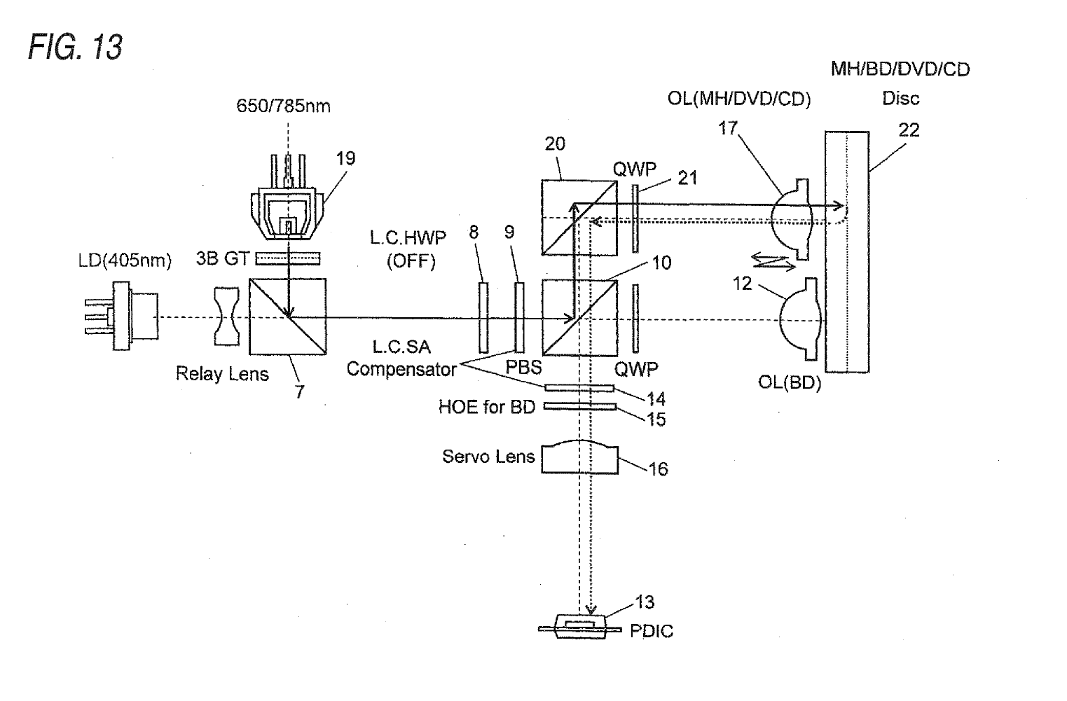

FIG. 13 shows a state in which the lens 17 is utilized for recording and playing back of a DVD 22.

That is, the DVD 22 records a signal on a side at a distance from the lens 17 (center portion) or reads a signal therefrom and thus the lens 17 having small NA can be utilized.

In this case, red laser light (650 nm) is emitted from the laser diode 19 and is reflected on the beam splitter 7 and a voltage is applied to the liquid crystal half wave plate 8 and thus the laser light is deflected as S polarization and is reflected on the beam splitter 10.

The red laser light reflected on the beam splitter 10 is reflected on the reflector 20 and passes through the quarter wave plate 21 and then is applied to the target portion of the DVD 22 through the lens 17.

Since this time is the recording time, the laser light applied to the DVD 22 is made stronger than that at the reading time and accordingly data is recorded on the DVD 22 to which the laser light has been applied.

Next, playback of the DVD 22 will be discussed.

The dashed line in FIG. 13 indicates the signal playback time; at this time, the laser light applied to the DVD 22 is made weaker than that at the recording time and thus devotedly the reflected wave from the DVD 22 is received at the light reception element 13 to provide a playback signal.

The reflected wave from the DVD 22 once passes through the quarter wave plate 21 before arriving at the lens 17 and thus again passes through as the reflected wave and becomes from S polarization to P polarization and therefore is reflected on the reflector 20 and passes through the beam splitter 10 and next arrives at the light reception element 13 as described above through the spherical aberration correction element 14, the BD tracking element 15, and the focus adjustment lens 16.

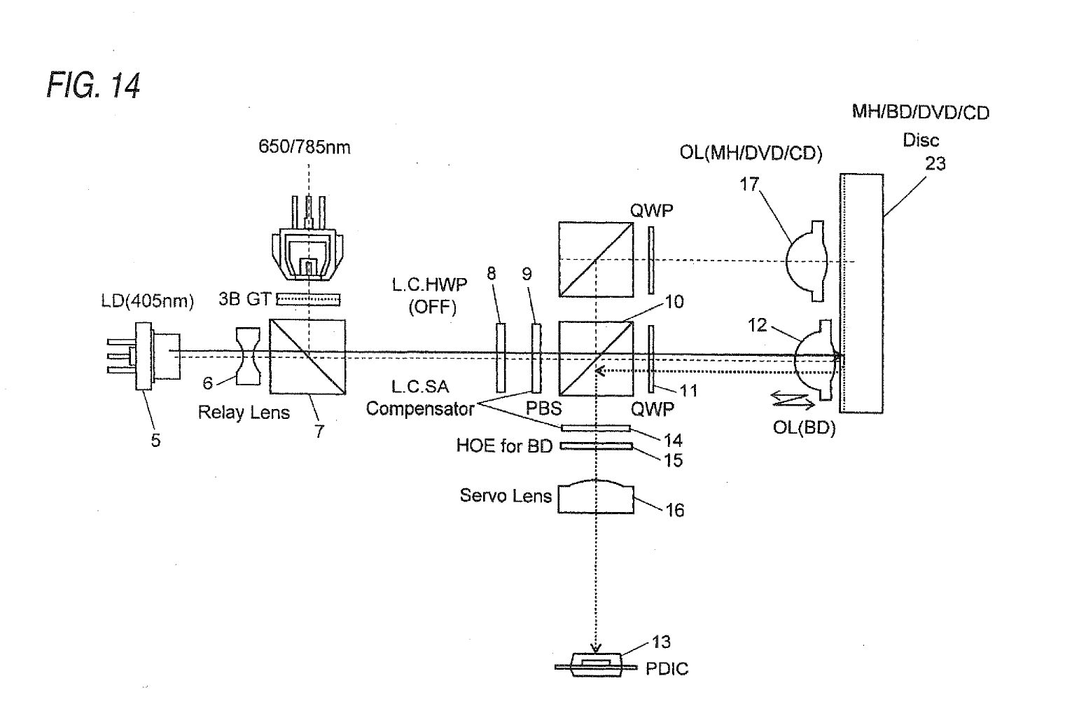

FIG. 14 shows a state in which the lens 12 is utilized for recording and playing back of a BD 23.

That is, the BD 23 records a signal in the proximity of the lens 12 or reads a signal therefrom and thus the lens 12 having large NA can be utilized.

To begin with, recording of the BD 23 will be discussed with FIG. 14.

Blue laser light (405 nm) emitted from the laser diode 5 passes through the relay lens 6, the beam splitter 7, the liquid crystal half wave plate 8, the spherical aberration correction element 9, the beam splitter 10, and the quarter wave plate 11, and is applied to the target portion of the BD 23 through the lens 12.

Since this time is the recording time, the laser light applied to the BD 23 is made stronger than that at the reading time and accordingly data is recorded on the BD 23 to which the laser light has been applied.

No voltage is applied to the liquid crystal half wave plate 8 and polarization direction is not changed.

Next, playback of the BD 23 will be discussed.

The dashed line in FIG. 14 indicates the signal playback time at this time, the laser light applied to the BD 23 is made smaller than that at the recording time and thus devotedly the reflected wave from the BD 23 is received at the light reception element 13 to provide a playback signal.

The reflected wave from the BD 23 once passes through the quarter wave plate 11 before arriving at the lens 12 and thus again passes through as the reflected wave and becomes from P polarization to S polarization and therefore is reflected on the beam splitter 10 and next arrives at the light reception element 13 as described above through the spherical aberration correction element 14, the BD tracking element 15, and the focus adjustment lens 16.

As described above, in the invention, multiple hologram layers are provided in the plate body in the thickness direction of the plate body, at least one of the multiple hologram layers is formed of spirally continuous hologram bands, the hologram band is formed with a hologram band erasure area by applying circular light having a larger diameter than the width in the direction orthogonal to the length direction of the hologram band, so that occurrence of noise at the playback time can be suppressed.

That is, each hologram band erasure area is formed by applying circular light having a larger diameter than the width in the direction orthogonal to the length direction of the hologram band. Thus, in the erasure area non-erasure hologram remaining in the width direction is small and consequently occurrence of noise at the playback time can be suppressed.

Thus, it can be expected that the record medium will be widely utilized as a record medium of various optical disk units.

This application claims the benefit of Japanese Patent application No. 2008-309401 filed on Dec. 4, 2008, the entire contents of which are incorporated herein by reference.

What is claimed is:

1. A record medium, comprising:
a plate body;
multiple hologram layers formed in a thickness direction of the plate body; and
a hologram band formed in at least one of the multiple hologram layers;
wherein the hologram band is formed with a hologram band erasure area having no hologram band in a direction orthogonal to the length direction of the hologram band.

2. The record medium as claimed in claim 1, wherein the hologram band is shaped as a spiral or a concentric circle.

3. The record medium as claimed in claim 1, wherein the hologram band erasure area is formed continuously in the length direction of the hologram band.

4. The record medium as claimed in claim 1 wherein a boundary between the hologram band and the hologram band erasure area is shaped as a straight line.

5. An optical disk unit comprising:
the record medium as claimed in claim 1; and
a light supplier being provided on one side of the record medium applying light to the record medium, wherein the hologram band is recorded by the light supplier.

6. The optical disk unit as claimed in claim 5, wherein a circular light having a larger diameter than a width in the direction orthogonal to the length direction of the hologram band from the light supplier is applied so as to form the hologram band erasure area.

7. The optical disk unit as claimed in claim 5, wherein the diameter of the circular light supplied from the light supplier is smaller than the width from one hologram band adjacent to the hologram band to which fight is applied to an opposite hologram band adjacent to the hologram band to which light is applied.

8. A record medium recording method an a record medium comprising a plate body, multiple hologram layers formed in a thickness direction of the plate body; and a hologram band formed in at least one of the multiple hologram layers, the method comprising:
forming an erasure area of the hologram band by applying circular light having a larger diameter than a width in a direction orthogonal to the length direction of the hologram band.

9. The record medium recording method as claimed in claim 8, wherein the hologram band is shaped as a spiral or a concentric circle.

10. A record medium comprising:
a plate body;
multiple hologram layers formed in a thickness direction of the plate body; and
a hologram band formed in at least one of the multiple hologram layers, wherein the hologram band is formed with an alternating pattern of an erasure area and a non-erasure area.

11. The record medium as claimed in claim 10, wherein a boundary between the erasure area and the non-erasure area is shaped as a straight line.

12. An optical disk unit comprising:
the record medium as claimed in claim 10; and
a light supplier being provided on one side of the record medium applying light to the record medium, wherein the optical disk unit recording each hologram band by the light supplier.
